(19) United States
(12) Patent Application Publication
(10) Pub. No.: US 2010/0277685 A1
(43) Pub. Date: Nov. 4, 2010

(54) Floatable eyewear

(76) Inventor: Chih-Ming Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,226

(22) Filed: May 4, 2009

(51) Int. Cl. G02C 11/00

(52) U.S. Cl. 351/43

(57) ABSTRACT

Floatable eyewear includes a lens unit and a frame holding the lens unit. The frame includes a main body and two temples attached to two sides of the main body. An empty chamber is defined in at least one of the main body and the temples to provide the eyewear with buoyancy. The empty chamber is outside of the lens unit.

### BACKGROUND OF THE INVENTION

The present invention relates to floatable eyewear and, more particularly, to eyewear including a floatable frame to provide the eyewear with buoyancy.

People suffering from myopia, hyperopia, and astigmatism need eyewear with correcting lenses to prevent water from entering the eyes while proceeding with activities in, on, or near water, such as fishing, swimming, diving, water volleyball, surfing, water motorcycling, water ballet, etc. However, it is not uncommon that the eyewear falls and, thus, sinks into the water, leading to inconvenience or even danger to the wearer trying to retrieve the eyewear. U.S. Patent Publication No. US20050144707 A1 discloses goggles for water-related activities including a frame and a wearing portion. The frame includes at least one loop portion receiving at least one lens unit. The lens unit includes two lenses and an airtight spacing loop securely sandwiched between the lenses, defining an isolated empty chamber for providing the goggles with buoyancy and, thus, enabling the goggles to float on water. However, it is difficult to manufacture correcting lenses with an isolated empty chamber.

FIG. 4 shows conventional eyewear including two temples 2. A foam 21 is bonded by adhesive to a side of each temple 2. The foam 21 is light and soft to provide the eyewear with buoyancy. However, the adhesive loses its function after the eyewear is immersed in water for a period of time, leading to falling of the foam 21 from the temples 2.

Thus, a need exists for a durable floatable eyewear.

### BRIEF SUMMARY OF THE INVENTION

Floatable eyewear according to the preferred teachings of the present invention includes a lens unit and a frame holding the lens unit. The frame includes an empty chamber providing the eyewear with buoyancy. The empty chamber is outside of the lens unit. In a most preferred form, the frame includes a main body and first and second temples attached to two sides of the main body. An empty chamber is defined in each of the main body and the first and second temples to provide the eyewear with buoyancy. Thus, when the eyewear falls from a wearer into water, the eyewear can float and, thus, can be easily found and retrieved by the wearer.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a diagrammatic perspective view of floatable eyewear according to the preferred teachings of the present invention.

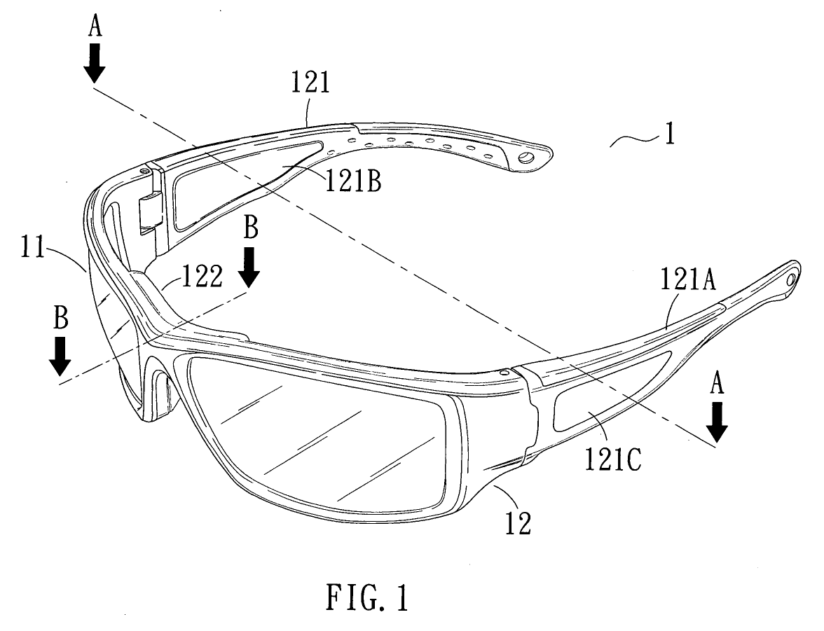

FIG. 2 shows a cross sectional view of the floatable eyewear of FIG. 1 according to section line A-A of FIG. 1.

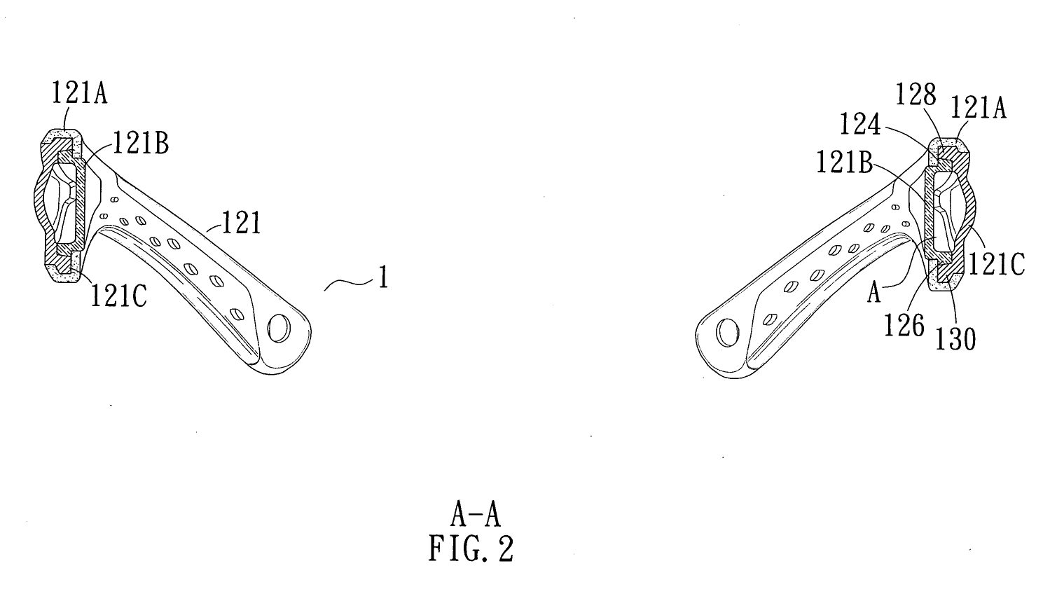

FIG. 3 shows a cross sectional view of the floatable eyewear of FIG. 1 according to section line B-B of FIG. 1.

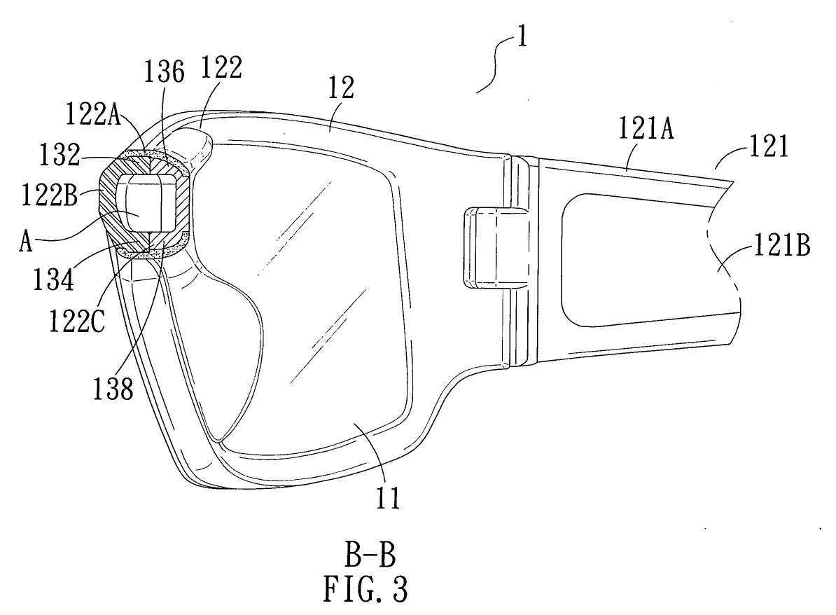

FIG. 4 shows a partial, cross sectional view of conventional eyewear.

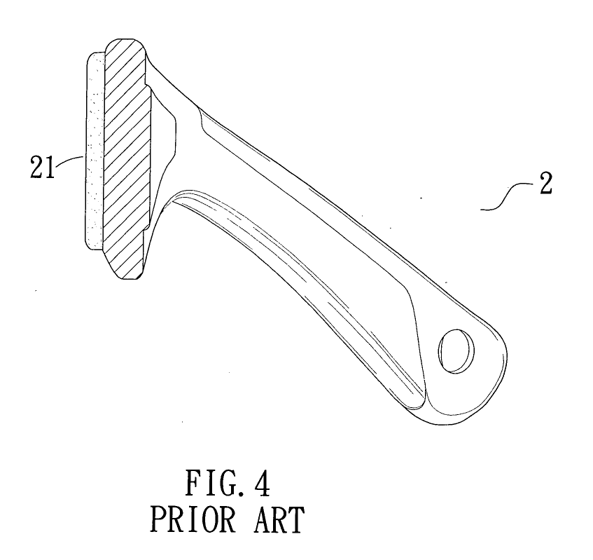

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

Floatable eyewear according to the preferred teachings of the present invention is shown in the drawings and generally designated 1. In the preferred form shown, the floatable eyewear 1 includes a lens unit 11 and a frame 12 holding the lens unit 11. In the most preferred form shown, the frame 12 includes a main body 122 and two temples 121 attached to two sides of the main body 122. Each of the main body 122 and the first and second temples 121 includes an empty chamber A, providing the eyewear 1 with buoyancy. The empty chambers A are outside of the lens unit 1.

Specifically, in the most preferred form shown, each of the first and second temples 121 includes an inner plate 121B and an outer plate 121C. The inner and outer plates 121B and 121C of each temple 121 together define one of the empty chambers A. An upper side 124 of the inner plate 121B is coupled to an upper side 128 of the outer plate 121C. A lower side 126 of the inner plate 121B is coupled to a lower side 130 of the outer plate 121C. Each of the first and second temples 121 further includes an enveloping member 121A enveloping the upper and lower sides 124, 126, 128, and 130 of the inner and outer plates 121B and 121C. The enveloping members 121A assure sealing of the empty chambers A in the temples 121 without the risk of leakage or disengagement between the inner and outer plates 121B and 121C. The enveloping member 121A can be made of a material the same as or different from the inner and outer plates 121B and 121C.

In the most preferred form shown, the main body 122 includes a front plate 122B and a rear plate 122C. The front and rear plates 122B and 122C together define one of the empty chambers A. The main body 122 further includes an enveloping member 122A enveloping upper and lower sides 132, 134, 136, 138 of the front and rear plates 122B and 122C. The enveloping member 122A can be made of a material the same as or different from the front and rear plates 122B and 122C. The enveloping member 122A assures sealing of the empty chamber A in the main body 122 without the risk of leakage or disengagement between the front and rear plates 122B and 122C.

The eyewear 1 can be of any shapes and types suitable for activities in, on, or near water.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Floatable eyewear comprising:
a lens unit; and
a frame holding the lens unit, with the frame including a first empty chamber providing the floatable eyewear with buoyancy, with the first empty chamber outside of the lens unit.

2. The floatable eyewear as claimed in claim 1, with the frame including a main body having two sides, with the frame further including first and second temples respectively attached to the two sides of the main body, and with the first temple including the first empty chamber.

3. The floatable eyewear as claimed in claim 2, with the first temple including a first inner plate and a first outer plate, with the first inner plate and the first outer plate together defining the first empty chamber, with each of the first inner plate and the first outer plate including upper and lower sides, with the upper side of the first inner plate coupled to the upper side of the first outer plate, with the lower side of the first inner plate coupled to the lower side of the first outer plate, and with the first temple further including a first enveloping member enveloping the upper and lower sides of the first inner plate and the first outer plate.

4. The floatable eyewear as claimed in claim 3, with the first enveloping member made of a material different from the first inner plate and the first outer plate.

5. The floatable eyewear as claimed in claim 3, with the second temple including a second inner plate and a second outer plate, with the second inner plate and the second outer plate together defining a second empty chamber, with each of the second inner plate and the second outer plate including upper and lower sides, with the upper side of the second inner plate coupled to the upper side of the second outer plate, with the lower side of the second inner plate coupled to the lower side of the second outer plate, and with the second temple further including a second enveloping member enveloping the upper and lower sides of the second inner plate and the second outer plate.

6. The floatable eyewear as claimed in claim 5, with the second enveloping member made of a material different from the second inner plate and the second outer plate.

7. The floatable eyewear as claimed in claim 5, with the main body including a front plate and a rear plate, with the front plate and the rear plate together defining a third empty chamber outside of the lens unit, with each of the front plate and the rear plate including upper and lower sides, and with the main body further including a third enveloping member enveloping the upper and lower sides of the front plate and the rear plate.

8. The floatable eyewear as claimed in claim 7, with the third enveloping member made of a material different from the front and rear plates.

9. The floatable eyewear as claimed in claim 1, with the frame including a main body holding the lens unit, and with the main body including the first empty chamber.

10. The floatable eyewear as claimed in claim 9, with the main body including a front plate and a rear plate, with the front plate and the rear plate together defining the first empty chamber, with each of the front plate and the rear plate including upper and lower sides, with the main body further including an enveloping member enveloping the upper and lower sides of the front plate and the rear plate.

11. The floatable eyewear as claimed in claim 10, with the enveloping member made of a material different from the front and rear plates.
